(19) United States
(12) Patent Application Publication
(10) Pub. No.: US 2018/0005623 A1
(43) Pub. Date: Jan. 4, 2018

(54) Voice Enhancing Device with Audio Focusing Function

(71) Applicant: EM-TECH. Co., Ltd., Busan (KR)

(72) Inventors: Choong Sheek Hong, Gyeonggi-do (KR); Dong Sung Kim, Gyeonggi-do (KR)

(21) Appl. No.: 15/640,764

(22) Filed: Jul. 3, 2017

(30) Foreign Application Priority Data
Jul. 4, 2016 (KR) 1020160084326

(51) Int. Cl. G10K 11/178; H04R 3/00; H04R 1/40; H04R 1/10; H04R 1/04

(52) U.S. Cl. CPC G10K 11/1786; H04R 1/1016; H04R 1/04; H04R 1/1041; H04R 1/406; H04R 3/005; G10K 2210/3056; G10K 2210/3046; G10K 2210/1081; H04R 2420/07

(57) ABSTRACT

A voice enhancing device with an audio focusing function is disclosed. The voice enhancing device has an audio focusing function capable of selectively enhancing voice depending on a speaking person's location. The voice enhancing device, which is wearable on a human body, includes: left and right earphones configured to fit into left and right ears of a wearer of the voice enhancing device, respectively; two or more microphones configured to acquire a sound; and a processing part configured to at least perform signal processing tasks for active noise cancellation on sound signals from the microphones and output processed sound signals to the earphones. The processing part is configured to perform the signal processing tasks to amplify only sound signals picked up from an interested direction and to attenuate sound signals picked up from other directions.

### PRIORITY CLAIM

The present application claims priority to Korean Patent Application No. 10-2016-0084326 filed on 4 Jul. 2016, the content of said application incorporated herein by reference in its entirety.

### TECHNICAL FIELD

The present invention relates to a voice enhancing device with an audio focusing function, and more particularly, to a voice enhancing device with an audio focusing function which is capable of selectively enhancing voice depending on a speaking person's location.

### BACKGROUND

In noisy environments such as plants, construction sites, or transportation means, earplugs for blocking out noise are widely used to protect the hearing function of workers. Such physical noise isolation, though, has limitations in terms of noise isolation performance, and also has a disadvantage of non-selectively blocking out every sound that should be heard, such as voices from people or warning signals.

Recently, active noise cancellation has been introduced to further improve noise reduction. Active noise cancellation, which is distinct from traditional passive noise cancellation, which physically blocks out noise, includes a process of analyzing outside noise and/or a process of generating a specific sound. Active noise cancellation is achieved through various signal processing algorithms, and the most typical among them is negative feedback using an inverted signal. In this method, when the user hears outside noise through a microphone, a sound with inverted phase to the noise is emitted, thereby significantly reducing outside noise. U.S. Pat. No. 4,985,925 and U.S. Laid-Open Patent Publication No. 2016-0063986 disclose such active noise-cancelling headsets.

This traditional active noise cancellation still has its limitations. Active noise cancellation, too, non-selectively blocks out outside noise, thus making it difficult for the user to perceive what is happening around them through their sense of hearing. What is more, active noise cancellation even blocks out human voice, which makes conversation between workers impossible. Another disadvantage is that, to initiate a conversation, they need to stop the operation of their noise cancelling device or take it off.

### SUMMARY

The present invention has been made to solve the foregoing problems. An object of the present invention is to provide a voice enhancing device with an audio focusing function which is capable of effectively blocking out noise in loud environments.

Another object of the present invention is to provide a voice enhancing device with an audio focusing function which, along with noise isolation, only amplifies sound signals picked up from an interested direction to allow the user to have conversation with people around them.

A further object of the present invention is to provide a voice enhancing device with an audio focusing function which, along with noise isolation, only enhances voice so that the user can hear a conversation with the other party more clearly.

According to an aspect of the present invention, there is provided a voice enhancing device with an audio focusing function, including: left and right earphones that fit into both ears; two or more microphones that acquire a sound; and a processing part that at least performs signal processing tasks for active noise cancellation on the sound signals from the microphones and outputs the processed sound signals to the earphones, wherein the processing part performs signal processing tasks to amplify only the sound signals picked up from an interested direction and to attenuate the sound signals picked up from other directions.

In some embodiments, the processing part at least determines the directions of the sounds picked up and detected by the two or more microphones, respectively, based on the difference in phase between the sounds.

In some embodiments, the voice enhancing device further includes a housing that receives at least some of the earphones, the microphones and the processing part, wherein the housing has a neckband shape, and the two or more microphones are placed apart from each other at the left and right sides of the housing,

In some embodiments, the two or more microphones are provided separately for the left and right earphones.

In some embodiments, the voice enhancing device further includes a housing that receives at least some of the earphones, the microphones and the processing part, wherein the housing has an eyeglass shape, and the two or more microphones are placed apart from each other at the left and right sides of the housing.

In some embodiments, the voice enhancing device includes an input part that sets the interested direction, wherein the processing part variably sets the interested direction based on an input for setting the interested direction from the input part.

In some embodiments, the voice enhancing device includes a communication part that performs wire or wireless communication with an electric communication device, wherein the processing part variably sets the interested direction based on an input for setting the interested direction from the communication part.

In some embodiments, the interested direction is the direction the wearer's ace is facing.

According to the present invention, the voice enhancing device has the effect of allowing the wearer to have conversation with people around them without taking it off, while effectively reducing ambient noise by active noise cancellation.

According to the present invention, the voice enhancing device has the effect of allowing the wearer to selectively hear sounds from a desired sound source by selectively cancelling noise depending on the direction.

According to the present invention, the voice enhancing device has the effect of allowing seamless communication even in loud environments by reducing ambient noise and enhancing voice picked up from an interested direction.

Those skilled in the art will recognize additional features and advantages upon reading the following detailed description, and upon viewing the accompanying drawings.

### BRIEF DESCRIPTION OF THE DRAWINGS

FIG. 1 is a schematic block diagram of a voice enhancing device with an audio focusing function according to an exemplary embodiment of the present invention.

FIG. 2 is an explanatory drawing illustrating the principle of determining the location of a sound source by a processing part.

FIG. 3 is a schematic diagram of a neckband type voice enhancing device with an audio focusing function according to an exemplary embodiment of the present invention.

FIG. 4 is a schematic diagram of an earset type voice enhancing device with an audio focusing function according to another exemplary embodiment of the present invention.

FIG. 5 is a schematic diagram of an eyeglass type voice enhancing device with an audio focusing function according to a further exemplary embodiment of the present invention.

### DETAILED DESCRIPTION

Hereinafter, a voice enhancing device with an audio focusing function according to exemplary embodiments of the present invention will be described in detail with reference to the drawings. In this specification, it will be readily appreciated that like reference numerals designating corresponding or like parts may be omitted in the drawings to facilitate understanding of the invention.

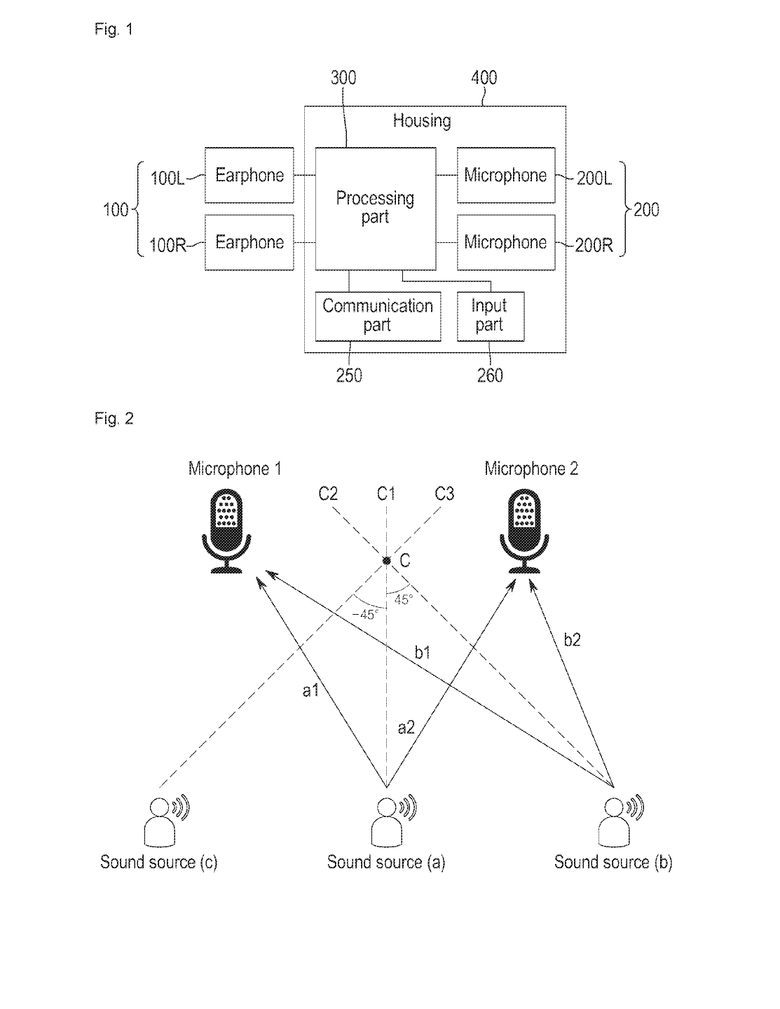

FIG. 1 is a schematic block diagram of a voice enhancing device with an audio focusing function according to an exemplary embodiment of the present invention. The voice enhancing device according to the exemplary embodiment of the present invention, which is wearable on a human body, may include an earphone part 100 that is a speaker part put on an auricle or inserted into an external auditory meatus to transfer a sound to the wearer's ear, a microphone part 200 that acquires an external sound, a processing part 300 that processes the sound from the microphone part 200 or outputs a sound signal for outputting the processed sound to the earphone part 100, and a housing 400 that receives at least one of the earphone part 100, the microphone part 200 and the processing part 300. In addition, the voice enhancing device may include a communication part 250 that can perform wire or wireless communication with an external electric communication device (e.g., smartphones, tablets, etc.) and an input part 260 that acquires an input value (e.g., an input for starting or stopping the audio focusing function, an input for setting an interested direction, an input for adjusting a volume of a sound signal, etc.) from the wearer (user).

The earphone part 100 may consist of a left earphone 100L and a right earphone 100R that fit into both ears. The earphone part 100 outputs a sound signal picked up from the microphone part 200, without being processed by the processing part 300, or outputs the sound signal, after being processed by the processing part 300, so that the wearer of the present device can hear it. The microphone part 200 may consist of a plurality of microphones 200L and 200R; especially, at least some of the plurality of microphones 200L and 200R is preferably spaced apart from the other. Thus, as shown in FIG. 1, the microphone part 200 may be divided into the left microphone 200L and the right microphone 200R. The microphone part 200 serves to pick up sound signals around the wearer of the present device and transmits the picked-up sound signals to the processing part 300.

The processing part 300 basically performs various signal processing tasks. To implement this functionality, the processing part 300 may include a microprocessor, for example. The processing part 300 analyzes sound signals going into the microphone part 200 to locate the directions of the respective sound sources. The technology of determining the location of the sound source of a picked-up sound using a plurality of microphones has been traditionally known. This technology works on the principle that a human determines the location of a sound source through both ears, in which the processing part 300 determines the direction of a sound source using the difference in phase and sound level between sound signals going into two or more microphones 200L and 200R placed apart from one another.

FIG. 2 is an explanatory drawing illustrating the principle of determining the location of a sound source by the processing part 300, which schematically shows sound signals a1 a2, b1, and b2 going into microphone 1 and microphone 2, placed apart from each other, from sound source (a) and sound source (b), placed apart from each other. The sound signals a1 and a2, which are picked up by the microphones 1 and 2 from the sound source (a) which is at the same distance from the microphones 1 and 2, have the same sound level and phase. This is because the sound signals a1 and a2 come from the same sound source (a) and are picked up by the two microphones 1 and 2 located at the same distance from it.

By contrast, the sound signals b1 and b2, which are picked up by the microphones 1 and 2 from the sound source (b) which is at different distances from the microphones 1 and 2, have different phases and sound levels. That is, the sound signal b1 and the sound signal b2 take different times to reach the microphone 1 and the microphone 2, respectively, thus resulting in a phase difference between the two signals, and there is a sound level difference because the microphones 1 and 2 are at different distances from the sound source (b), As a consequence, the larger the difference in distance between the two separated microphones 1 and 2 and the sound source, the greater the difference in phase and sound level between the sound signals reaching the respective microphones 1 and 2. Based upon this, it is possible to find the location of the sound source. For example, it is possible to determine the location or direction of the sound source based on a position angle A (azimuth) between an extension line C1 of a midpoint C perpendicular to extension line of the microphone 1 and the microphone 2 and an extension line C2 of the sound source (b) and the midpoint C. The sound source (a) corresponds to an angle of 0°, the sound source (b) is set to be in the location or direction corresponding to an angle of 45°, and the sound source (c) is set to be in the location or direction corresponding to an angle of −45°.

Using the principle depicted in FIG. 2, the processing part 300 is thus able to locate the sound source of sound signals going into the microphone part 200 and therefore perform signal processing tasks. That is, the processing part 300 performs an audio focusing function, in particular to enhance, i.e., amplify sound signals coming from a certain direction (interested direction; direction of the sound source) where the desired sound source is located and to attenuate sound signals picked up from other directions. For example, the processing part 300 may only amplify human voice, out of sound signals coming from an interested direction, so that it can be heard clearly. This can be achieved simply, by increasing the volume of sounds in midrange frequencies in which human voice mostly falls, or through the use of various signal processing algorithms, with respect to the sound signals picked up from the interested direction. Moreover, the sound signals picked up from directions other than the interested direction may be attenuated by active noise cancellation. In this case, the processing part 300 may cancel or attenuate an unwanted sound signal picked up from other directions by generating a signal with inverted phase to the sound signal and emitting it to the earphone part 100. It will be obvious to those skilled in the art that a detailed method of active noise cancellation using phase inversion, which is performed by the processing part 300 as described above, may be implemented well enough by using a well-known method or algorithm.

Moreover, preferably, the direction the face of the wearer of the voice enhancing device of the present invention is facing may be set as the interested direction. The direction the wearer's face is facing may correspond to a case that, for example, the position angle A is 0°. Here, the interested direction may be preset in advance, or the processing part 300 may acquire the position angle A corresponding to the interested direction from the communication part 250 or the input part 260 to variably set the interested direction. The processing part 300 may further include other components required to perform the above functions, for example, a communication circuit, a control circuit, a battery for power supply, etc.

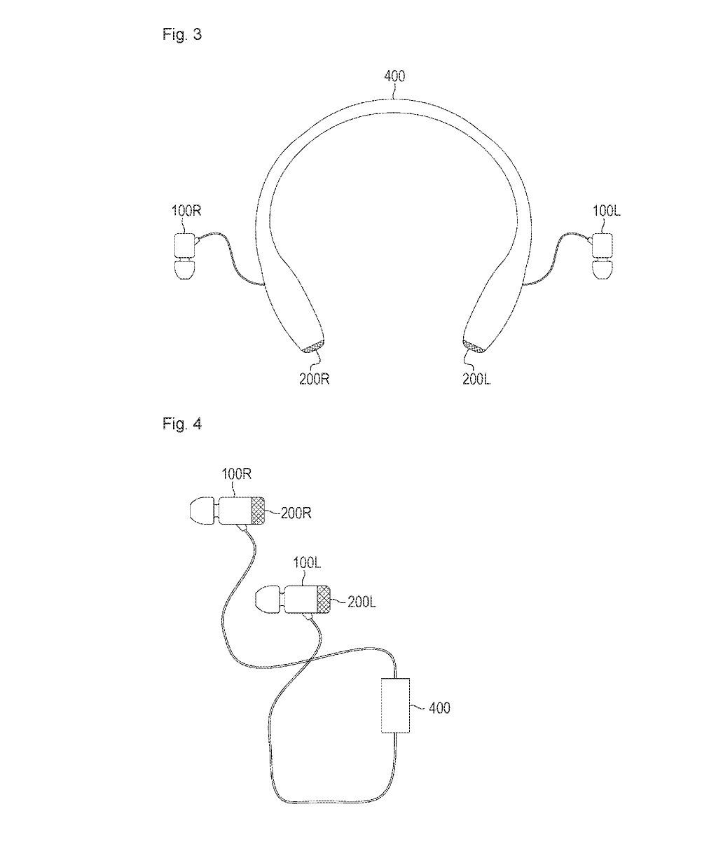

FIG. 3 is a schematic diagram of a neckband type voice enhancing device according to an exemplary embodiment of the present invention. Microphones 200L and 200R are placed apart from each other at the left and right sides of a neckband-shaped housing 400, and left and right earphones 100L and 100R, too, are placed apart from each other at the left and right sides of the housing 400 so as to fit into both ears. Although not shown in the drawings, the processing part 300 may be provided within the housing 400.

FIG. 4 is a schematic diagram of an earset type voice enhancing device according to another exemplary embodiment of the present invention. Two microphones 200L and 200R may be located at the rear ends of the earphones 100L and 100R that fit into both ears. The processing part 300 may also be provided within a small-sized housing 400. The microphones 200L and 200R may also be spaced enough at the left and right sides as the two earphones 100L and 100R are spaced apart from each other to fit into the human ears.

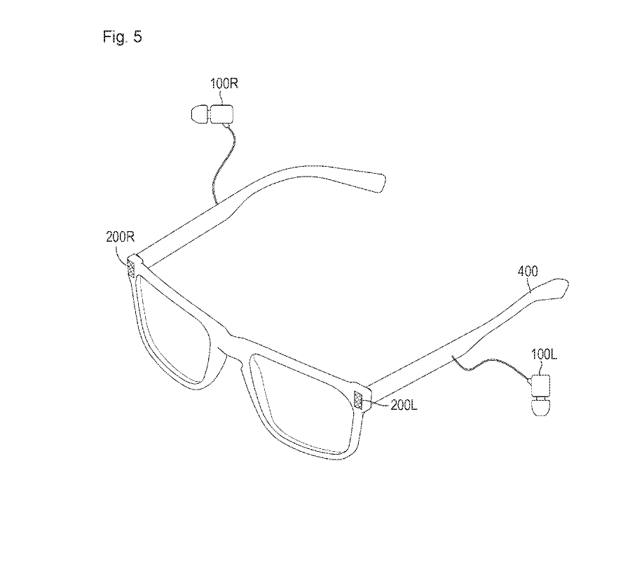

FIG. 5 is a schematic diagram of an eyeglass type voice enhancing device according to a further exemplary embodiment of the present invention. A plurality of microphones 200L and 200R are placed apart from one another at the left and right sides of an eyeglass-shaped housing 400, and left and right earphones 100L and 100R, too, are placed apart from each other at the left and right sides of the housing 400 so as to fit into both ears. The processing part 300, of course, may be provided within the housing 400.

The voice enhancing device of the present invention is wearable on a human body, and is therefore turned in the direction the human body is facing; especially, the voice enhancing devices according to the exemplary embodiments of FIGS. 4 and 5 may be turned in the direction the face is facing. Thus, when the wearer turns their face towards an interested sound source, the voice enhancing devices according to the exemplary embodiments of FIGS. 4 and 5 may be automatically turned in the same direction, and therefore the interested direction may be set based on the direction the wearer's face is facing. Moreover, the neckband type voice enhancing device according to the exemplary embodiment of FIG. 3 follows the direction the wearer's body is facing, and therefore the interested direction may be set based on the direction the wearer's body is facing. That is, since the wearer is supposed to turn their body or face towards a desired sound source (a person, machinery, etc.), the interested direction may be preferably set to the direction the wearer's face or body is currently facing. In some embodiments, the wearer of the voice enhancing device of the present invention may directly control the interested direction (i.e., the direction from which they want to hear sound) through the input part 260 as needed. For this control, various control methods for controlling electronic equipment according to the related art may be used, such as a smartphone application. That is, the voice enhancing device of the present invention—if it includes the communication part 250 that enables wireless connection—may be connected to a smartphone that will be used as a controller (preferably via a wireless connection such as Bluetooth), and the interested direction may be controlled freely through a control application of the connected smartphone. In this case, the connection between the voice enhancing device and the smartphone may be made by the processing part 300. By allowing the wearer to control the interested direction, the wearer can clearly hear sound signals from a sound source located in a desired direction, without turning their face or body. Especially by way of the smartphone application, the wearer may control the interested direction easily in real time.

There are advantages unique to the present invention that could be explicitly derived from the above-described exemplary embodiments. That is, the voice enhancing device of the present invention may selectively amplify sounds from a desired sound source so as to be heard even in loud environments with high ambient noise, by enhancing sound signals coming from a sound source in the direction the wearer's face or body is facing and effectively attenuating sound signals picked up from other directions by active noise cancellation. Moreover, the voice enhancing device of the present invention allows for selective hearing or noise cancellation in any directions other than the direction the wearer's face or body is facing, by controlling the interested direction from which the wearer wants to hear sound, through the use of a smartphone application.

While this invention has been described in connection with what is presently considered to be practical exemplary embodiments, it is to be understood by those skilled in the art that the invention is not limited to the disclosed embodiments, but on the contrary, is intended to cover various modifications and equivalent arrangements included within the spirit and scope of the appended claims.

What is claimed is:

1. A voice enhancing device with an audio focusing function, which is wearable on a human body, comprising:
left and right earphones configured to fit into left and right ears of a wearer of the voice enhancing device, respectively;
two or more microphones configured to acquire a sound; and
a processing part configured to at least perform signal processing tasks for active noise cancellation on sound signals from the microphones and output processed sound signals to the earphones,
wherein the processing part is configured to perform the signal processing tasks to amplify only sound signals picked up from an interested direction and to attenuate sound signals picked up from other directions.

2. The voice enhancing device of claim 1, wherein the processing part is configured to at least determine the directions of the sounds picked up and detected by the two or more microphones, respectively, based on the difference in phase between the sounds.

3. The voice enhancing device of claim 1, further comprising:
a housing that receives at least some of the earphones, the microphones and the processing part,
wherein the housing has a neckband shape, and the two or more microphones are placed apart from each other at left and right sides of the housing.

4. The voice enhancing device of claim 1, wherein the two or more microphones are provided separately for the left and right earphones.

5. The voice enhancing device of claim 1, further comprising:
a housing that receives at least some of the earphones, the microphones and the processing part,
wherein the housing has an eyeglass shape, and the two or more microphones are placed apart from each other at the left and right sides of the housing.

6. The voice enhancing device of claim 1, further comprising:
an input part configured to set the interested direction,
wherein the processing part is configured to variably set the interested direction based on an input for setting the interested direction from the input part.

7. The voice enhancing device of claim 1, further comprising:
a communication part configured to perform wire or wireless communication with an electric communication device,
wherein the processing part is configured to variably set the interested direction based on an input for setting the interested direction from the communication part.

8. The voice enhancing device of claim 1, wherein the interested direction is a direction the wearer's face is facing.
